(19) United States
(12) Patent Application Publication
(10) Pub. No.: US 2026/0246779 A1
(43) Pub. Date: Aug. 20, 2026

(54) DYNAMIC ACCESS CONTROL OF COMPUTING RESOURCES BASED ON COMMUNICATION MECHANISM

(71) Applicant: Red Hat, Inc., Raleigh, NC (US)

(72) Inventors: Leigh Griffin, Waterford (IE); Andrea Cosentino, Rome (IT)

(21) Appl. No.: 19/054,547

(22) Filed: Feb. 14, 2025

(51) Int. Cl. H04L 9/40

(52) U.S. Cl. CPC H04L 63/102

(57) ABSTRACT

In certain aspects, an access control system can implement dynamic access control of computing resources based on a communication mechanism used to access the computing resources. The access control system can receive an access request from a client device via a communication channel. The access request can indicate a requested computing resource to which the client device is requesting access. The access control system can determine a risk profile related to the communication channel of the client device. The risk profile can indicate a level of trustworthiness of the communication channel. The access control system can provide access by the client device to an isolated environment including the requested computing resource. The isolated environment can be configured based on the risk profile.

### TECHNICAL FIELD

The present disclosure relates generally to access control of computing resources. More specifically, but not by way of limitation, this disclosure relates to using dynamic access control to control access to computing resources based on a communication mechanism.

### BACKGROUND

Distributed computing systems (e.g., cloud computing systems, data grids, and computing clusters) have recently grown in popularity given their ability to improve flexibility, responsiveness, and speed over conventional computing systems. A cloud computing system can be implemented using one of several deployment models, such as a private cloud, a public cloud, or a hybrid cloud. A public cloud environment can be created using computing infrastructure that is not owned by an end user.

### BRIEF DESCRIPTION OF THE DRAWINGS

FIG. 1 is a block diagram of an example of a computing environment for using dynamic access control to control access to one or more computing resources based on a communication mechanism according to some examples of the present disclosure.

FIG. 2 is a block diagram of another example of an isolated environment for controlling access to one or more computing resources based on a communication mechanism according to some examples of the present disclosure.

FIG. 3 is a block diagram of another example of a computing environment for using dynamic access control to control access to one or more computing resources based on a communication mechanism according to some examples of the present disclosure.

FIG. 4 is a flowchart of a process for using dynamic access control to control access to one or more computing resources based on a communication mechanism according to some examples of the present disclosure.

### DETAILED DESCRIPTION

A computing device often has a variety of communication channels available to communicate with other computing devices. In some cases, the computing device can be an Internet of Things (IoT) device that can be part of a network of computing devices that can collect and share data, such as data collected by sensors embedded in the computing devices. The computing devices in the network can share the data using at least one of the communication mechanisms. The communication channels can include wireless communication techniques, such as Bluetooth, Wi-Fi, or infrared (IR), or communication protocols, such as Hypertext Transfer Protocol (HTTP) or Transport Layer Security (TLS). Each communication channel can have a respective set of capabilities and risk vector. Due to variations in capability and risk of the communication channels, it can be difficult to maintain optimal network performance and security. A malicious actor can exploit less secure or less efficient communication channels, thereby compromising an overall security, efficiency, and reliability of an IoT network.

Some examples of the present disclosure can overcome one or more of the issues mentioned above by using an access control system to dynamically control access to computing resources based on a communication mechanism. As an example, a client device can communicate with a target device via a communication channel to access a computing resource, such as a service or a file, of the target device. Based on a risk profile or level of trustworthiness of the communication channel, the access control system can enable or prevent access to the computing resource. For example, the access control system can adjust deployment capabilities of an isolated environment (e.g., a virtual private cloud (VPC), a container, a virtual machine, etc.) based on a type of communication mechanism used by the client device. In some cases, the access control system can evaluate each communication channel of the client device based on a set of criteria to determine a respective level of trustworthiness or risk. Based on the evaluation of each communication channel, the access control system can provide customized access by the client device to certain computing resources. For example, the access control system can alter a configuration, permissiveness, or one or more services provided by the isolated environment. The access control system can provide flexibility to adapt permissiveness with respect to accessing protected computing resources using different communication mechanisms that may each have a respective risk profile. Access to the protected computing resources can be tailored using a trust-based approach, thereby protecting data, services, devices, or a combination thereof that are accessible by the client device.

In one particular example, the access control system can receive an access request from a client device to request access to a service provided by a computing device. In particular, the access control system can receive the access request from the client device via an infrared communication channel. The access control system can determine a risk profile associated with the infrared communication channel. The risk profile can indicate a level of risk associated with the infrared communication channel. Based on the risk profile, the access control system can determine whether to grant access by the client device to the service provided by the computing device. The service can be associated with a predefined threshold indicating an acceptable level of risk with respect to accessing the service. In some implementations, the access control system can determine that the level of risk associated with the infrared communication channel exceeds the predefined threshold associated with the service. As a result, the access control system can deny access to the service, such as by providing an isolated computing environment to the client device in which the service is unavailable. In other implementations the access control system can determine that the level of risk associated with the infrared communication channel meets or is below the predefined threshold associated with the service. Accordingly, the access control system can generate a configuration of the isolated computing environment that deploys the service, thereby enabling the client device to access the service.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

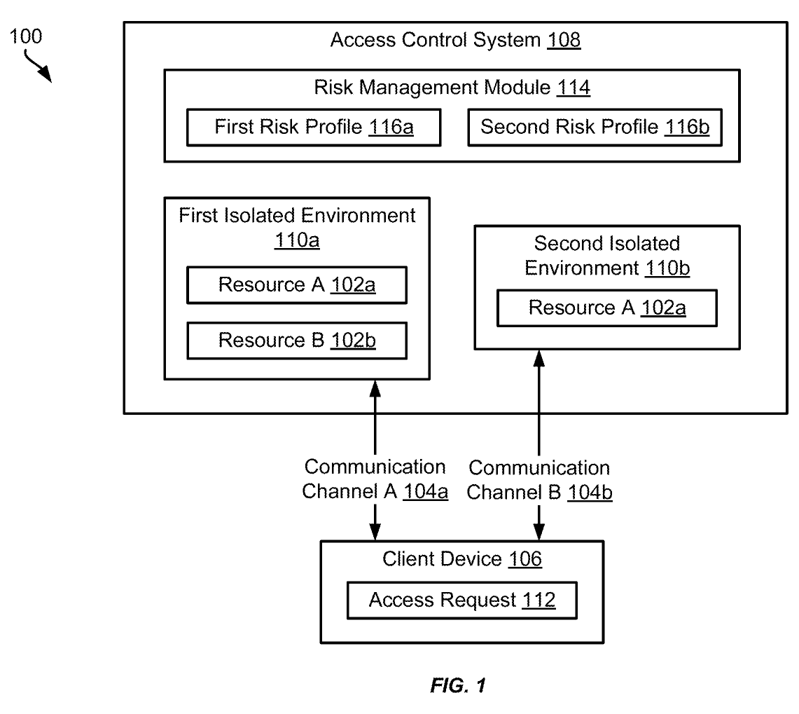

FIG. 1 is a block diagram of an example of a computing environment 100 for using dynamic access control to control access to one or more computing resources 102 based on a communication mechanism according to some examples of the present disclosure. Components within the computing environment 100 may be communicatively coupled such that communication can be implemented using one or more communication channels 104. The communication channels 104 described herein can be a type of communication mechanism. As shown in FIG. 1, a client device 106 can use a first communication channel 104a or a second communication channel 104b to transmit or receive messages, requests, or other types of communication. Examples of the client device 106 can include a desktop computer, single-board computer, laptop computer, server, mobile phone, or tablet. An example of the communication channels 104 can include a network, such as a cellular network, a local area network (LAN), wide area network (WAN), the Internet, or any combination thereof. Other examples of the communication channels 104 can include wireless communication techniques, such as Wi-Fi, Bluetooth, or infrared communication. Additionally, or alternatively, the communication channels 104 can include communication protocols, such as Transmission Control Protocol (TCP), Hypertext Transfer Protocol (HTTP), or Secure Sockets Layer (SSL). In some examples, a particular type of communication channel can include one or more subtypes. For example, Wi-Fi can be provided using different radio frequency bands, such as a 2.4 GHz band or a 5 GHz band, which can support different data transfer rates.

As shown in FIG. 1, the computing environment 100 can include an access control system 108 that can control access by the client device 106 to the computing resources 102. Examples of the computing resources 102 can include software services (e.g., a microservice, serverless application, or application). Other types of the computing resources 102 are possible, such as a file, a file system, a database, or other suitable system resources. In some implementations, the access control system 108 can manage one or more isolated environments 110 that can each include a respective set of the computing resources 102. Managing the isolated environments 110 can include configuring, generating, removing, deactivating, or other suitable actions related to the isolated environments 110. In some examples, the client device 106 can transmit an access request 112 to the access control system 108 to obtain or otherwise access a requested computing resource of the computing resources 102. The access control system 108 can enable or prevent the client device 106 from accessing the requested computing resource based on a security risk associated with the communication channel 104 used by the client device 106 to transmit the access request 112. In certain aspects, the access request 112 can indicate the requested computing resource, such as using metadata or by including an identifier associated with the requested computing resource. In some implementations, certain computing resources can be associated with a respective security requirement that can be used by the access control system 108 to restrict access by the client device 106 to these computing resources.

In some examples, the access control system 108 can include one or more target computing devices to which the client device 106 can initiate communication. For example, the client device 106 can initiate communication by using a specific communication channel to transmit the access request 112 to a particular target computing device. Examples of the target computing devices can include a desktop computer, single-board computer, laptop computer, server, mobile phone, or tablet. In some implementations, the target computing devices can be an edge device or a resource-constrained device. In certain aspects, the target computing devices or the client device 106 can be an Internet-of-Things (IoT) device. The access request 112 can indicate the requested computing resource hosted by a particular target computing device that the client device 106 is requesting to access. By way of example, the client device 106 can generate the access request 112 to access a login service of a particular target computing device. The login service can enable the client device 106 to log into and access a software application deployed in the particular target computing device.

In some examples, the access control system 108 can evaluate the communication channels 104 available for use by the client device 106 to determine a respective risk profile corresponding to each communication channel. For example, the access control system 108 can include a risk management module 114 that can evaluate the communication channels 104 using a set of criteria to determine a respective level of trustworthiness or risk. The set of criteria can be used to determine a respective likelihood of the communication channels 104 being breached, exposed, or otherwise compromised. In some examples, the set of criteria can account for vulnerabilities (e.g., common vulnerabilities and exposures) of each communication channel. Additionally, or alternatively, the set of criteria can be determined based on governance, such as rules or regulations determined by a rule-setting organization, an oversight agency, a government, etc. Based on the evaluation, the risk management module 114 can determine the respective risk profile of each communication channel. As shown, a first risk profile 116a can correspond to the first communication channel 104a, while a second risk profile 116b can correspond to the second communication channel 104b. In some implementations, the risk profiles 116 can include a respective score or value that can quantify a level of risk or a level of trustworthiness of a corresponding communication channel. By way of example, the first communication channel 104a can be a mobile hotspot provided using a personal mobile device, while the second communication channel 104b can be an unprotected public Wi-Fi network. The risk profiles 116a-b determined by the access control system 108 can indicate that the first communication channel 104a is more secure or more trustworthy compared to the second communication channel 104b. For example, the first risk profile 116a can include a lower risk score compared to the second risk profile 116b.

In some examples, the access control system 108 can determine whether to allow access by the client device 106 to the requested computing resource based on the risk profile 116 of the communication channel 104 used to transmit the access request 112. Additionally, the access control system 108 can determine whether the client device 106 is authorized or eligible to access the requested computing resource based on access permissions associated with the requested computing resource. In some implementations, using the access request 112, the access control system 108 can determine a security requirement associated with the requested computing resource, such as a minimum level of security or a maximum threshold of risk. The access control system 108 then can compare the risk profile 116 with the security requirement to determine whether risk associated with the communication channel 104 meets the security requirement. Additionally, or alternatively, each computing resource can be assigned a respective access level that can be compared with the risk profile 116 of the communication channel 104 in use by the client device 106.

Based on the risk profile 116 being compatible with the security requirement of the requested computing resource, the requested computing resource can be deployed or otherwise made available to the client device 106. In particular, the access control system 108 can deploy the requested computing resource in an isolated environment 110. In certain aspects, the isolated environment 110 can be a secure computing environment separated from a remaining portion of the computing environment 100, such as for data protection or security purposes. In some examples, the access control system 108 can include one or more containers, virtual machines, or other suitable computing components that can provide an isolated computing environment. By way of example, the access control system 108 can deploy the requested computing resource in a particular container to which the client device 106 is provided access. In some implementations, the access control system 108 can instantiate or otherwise generate the isolated environment 110, such as after receiving the access request 112. In other implementations, the access control system 108 can modify an existing isolated environment to include the requested computing resource. In some examples, the access control system 108 can include a combination of different types of isolated computing environments, such as a combination of containers and virtual machines.

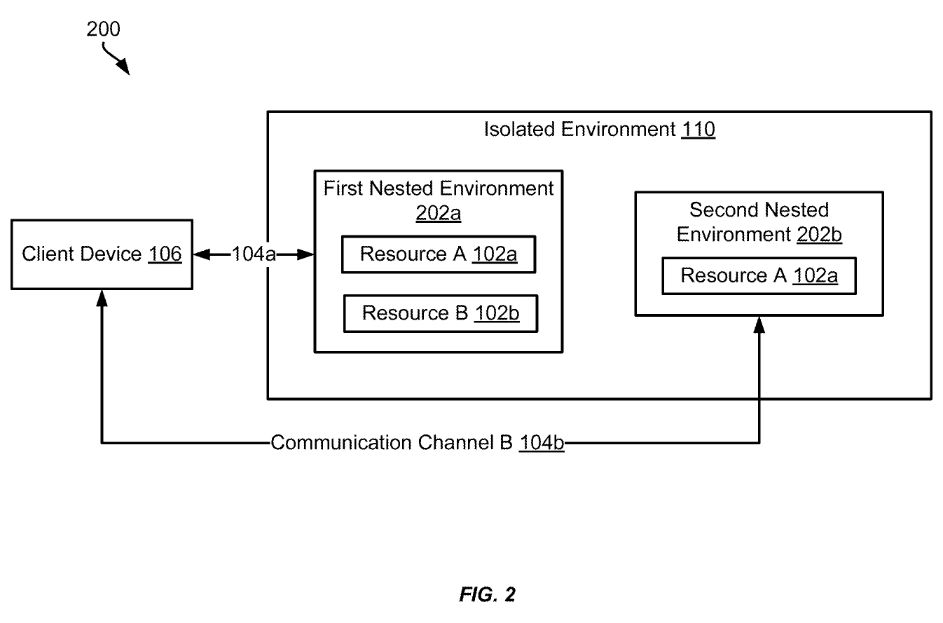

In some examples, the access control system 108 can be part of a virtual private cloud (VPC) that can provide a secure, isolated network that can be hosted in a public cloud. A public cloud can provide computing resources that can be shared by multiple entities (e.g., companies, organizations, users, etc.). In contrast, a private cloud can provide its computing resources to a single entity. In other words, access to the computing resources provided by the private cloud can be restricted to the single entity. The VPC can be a private cloud hosted within the public cloud, thereby forming an isolated computing environment. In some examples, the VPC can use the access control system 108 to modify its configuration or computing resources 102 deployed within based on the communication channel 104 in use by the client device 106. As described herein, each communication channel can be associated with a respective risk profile that can indicate a respective trustworthiness of a corresponding communication channel. In some examples, the VPC can use the access control system 108 proactively deploy certain permission-based or policy-based approaches based on a specific communication channel being in use by the client device 106. Examples of such approaches are further described below. In some examples, the VPC can create one or more nested VPCs that can each provide a respective isolated computing environment. The VPC can deploy a respective set of computing resources 102 within each nested VPC. In some implementations, the VPC can generate a respective nested VPC corresponding to each communication channel of the client device 106. The respective set of computing resources 102 provided in each nested VPC can be customized or specific to a corresponding communication channel, such as based on a respective risk profile of each communication channel. Additional description related to this aspect is provided below with respect to FIG. 2.

In some examples, the access control system 108 can grant the client device 106 access to a different isolated environment depending on which communication channel is used and its corresponding risk profile. Each isolated environment can include a respective set of computing resources 102 deployed within. In particular, each isolated environment can provide access to different computing resources. For example, as shown in FIG. 1, a first computing resource 102a and a second computing resource 102b can be deployed in a first isolated environment 110a. A second isolated environment 110b can include the first computing resource 102a but may lack the second computing resource 102b. In some implementations, the access control system 108 can allow the client device 106 to access different computing resources based on the risk profile 116 of the communication channel 104 selected by the client device 106. For example, the risk profiles 116a-b may indicate that the second communication channel 104b is associated with a higher level of risk compared to the first communication channel 104a. Consequently, if the client device 106 uses the first communication channel 104a, the access control system 108 may provide access to more computing resources compared to if the second communication channel 104b is used.

In some examples, the client device 106 may change which communication channel is used for communication purposes, such as to access the requested computing resource. In certain aspects, the change in the communication channel 104 can occur automatically (e.g., without manual intervention). For example, the client device 106 can automatically switch to the second communication channel 104b due to determining that the first communication channel 104a lacks sufficient connectivity or is otherwise unavailable. In other aspects, the change in the communication channel 104 can occur at least in part due to user input provided by a user to the client device 106, such as to manually switch from a Wi-Fi connection to a cellular connection on a mobile device.

In some examples, the access control system 108 can detect a change in which communication channel of the client device 106 is in use. For example, the access control system 108 can determine that the client device 106 has switched from the first communication channel 104a to the second communication channel 104b. In certain aspects, the access control system 108 can use a respective format of each communication channel to detect the change in the communication channel 104. For example, each communication channel may use a different communication protocol or other format that can be used to identify a particular communication channel currently in use by the client device 106.

In some implementations, the change in the communication channel 104 can affect the risk profile 116 of the communication channel 104. For example, the change in the communication channel 104 can involve switching from a current communication channel to a different communication channel associated with a lower level of trustworthiness (e.g., a higher level of risk). In some examples, the change in the communication channel 104 can include switching from a first type of communication channel to a second type of communication channel that can have a different risk profile than the first type of communication channel. By way of example, the change in the communication channel 104 can involve a switch from an SSL protocol to a TLS protocol. TLS is an upgraded version of SSL that addresses or resolves certain vulnerabilities of SSL. Accordingly, the TLS protocol can be associated with a different risk profile than the SSL protocol, such having a lower level of risk compared to the SSL protocol.

Once the access control system 108 detects the change in the communication channel 104, the access control system 108 can modify the isolated environment 110 accessible by the client device 106. For example, if the change in the communication channel 104 includes a change to the risk profile 116, the access control system 108 can adjust which computing resources are deployed in the isolated environment 110. In particular, if the risk profile 116 of the communication channel 104 in use after the change or switch has a lower level of trustworthiness than a previous risk profile, the access control system 108 may remove access by the client device 106 to the requested computing resource. Removing access to the requested computing resource can include, for example, removing access to the isolated environment 110 in which the requested computing resource is provided or deployed. For example, removing access to the isolated environment 110 can include modifying (e.g., deleting or deactivating) the isolated environment 110. Additionally, or alternatively, the access control system 108 can adjust access permissions of the client device 106 such that the client device 106 is no longer permitted to access the isolated environment 110. The access control system 108 can maintain the isolated environment 110 such that access to the isolated environment 110 can be reverted or returned to the client device 106 at a future time (e.g., based on a future change to the risk profile 116). As another example, removing access to the requested computing resource can include deleting or otherwise removing access to an instance of the requested computing resource deployed in the isolated environment 110.

In some implementations, the access control system 108 may allow the client device 106 to access a different isolated computing environment based on the change to the risk profile 116. For example, if the client device 106 requested access to the first computing resource 102a, the access control system 108 may switch the client device 106 from being permitted to access the first isolated environment 110a to instead access the second isolated environment 110b. As described herein, the second isolated environment 110b can provide fewer computing resources compared to the first isolated environment 110a. Accordingly, the second isolated environment 110b can be associated with fewer security requirements compared to the first isolated environment 110a. The second isolated environment 110b can enable the client device 106 to maintain access to the requested computing resource while decreasing security risks associated with a less trustworthy communication channel.

While FIG. 1 depicts a specific arrangement of components, other examples can include more components, fewer components, different components, or a different arrangement of the components shown in FIG. 1. For instance, in other examples, more than two communication channels or isolated environments may be present. Additionally, or alternatively, in other examples, the access control system 108 can be part of a virtual private cloud (VPC) that can include one or more edge devices that can provide a respective set of computing resources. Additionally, any component or combination of components depicted in FIG. 1 can be used to implement the process(es) described herein.

FIG. 2 is a block diagram of another example of an isolated environment 110 for controlling access to computing resources 102 based on a communication mechanism according to some examples of the present disclosure. In some examples, the isolated environment 110 can include one or more nested environments 202. Each nested environment can be created to correspond to a respective communication channel used by a client device 106. In some examples, an access control system 108 (e.g., the access control system described with respect to FIG. 1) can manage more than one isolated environment that can each include a respective set of the nested environments 202. Each isolated environment can correspond to a respective client device or a respective user. For example, each nested environment of the respective set of the nested environments 202 can correspond to a respective set of communication channels available for use in each client device. Certain aspects of FIG. 2 are described below with reference to components of FIG. 1.

As shown in FIG. 2, the isolated environment 110 can include a first nested environment 202a and a second nested environment 202b. An example of the nested environments 202 can include nested containers that can be run or deployed in another container. Another example of the nested environments 202 can include nested virtual private clouds (VPCs) that can be created within a VPC. Each nested environment 202 can include a respective set of computing resources 102 deployed within. As shown in FIG. 2, the first nested environment 202a includes a first computing resource 102a and a second computing resource 102b. The first computing resource 102a is also deployed within the second nested environment 202b. As described herein, the computing resources 102 can include software services, files, applications, file systems, databases, or other suitable system resources. In some examples, each nested environment 202 can provide a respective isolated computing environment. For example, each nested environment 202 can be a secure environment separate from other nested environments in the isolated environment 110.

In some examples, the access control system 108 can automatically route suitable communications from the client device 106 to a respective nested environment. In particular, the access control system 108 can select a particular nested environment based on a risk profile 116 of a communication channel 104 used by the client device 106 to transmit the communications. Once the particular nested environment is selected, the access control system 108 can provide access by the client device 106 to the particular nested environment. For example, the access control system 108 may route communications transmitted via a first communication channel 104a to the first nested environment 202a based on a first risk profile 116a of the first communication channel 104a. Similarly, the access control system 108 can route other communications transmitted using a second communication channel 104b to the second nested environment 202b based on a second risk profile 116b of the second communication channel 104b. Different levels of risk or trustworthiness associated with the communication channels 104a-b can result in different computing resources being provided in a corresponding nested environment.

In some examples, each nested environment can correspond to a respective communication channel. For example, the access control system 108 can generate a respective nested environment based on each risk profile of a corresponding communication channel. The respective set of computing resources 102 provided in each nested environment can be selected such that the corresponding communication channel’s risk profile is compatible with each security requirement of the computing resources 102. By way of example, the first nested environment 202a shown in FIG. 2 can include the first computing resource 102a and the second computing resource 102b. In contrast, the second nested environment 202b can include the first computing resource 102a but not the second computing resource 102b. The second risk profile 116b may be incompatible with a particular security requirement of the second computing resource 102b. For example, the second computing resource 102b may require an encrypted connection. Consequently, the client device 106 may be unable to access the second computing resource 102b using the second communication channel 104b.

As described herein, a change to the communication channel 104 in use by the client device 106 can cause a change to the isolated environment 110 accessible by the client device 106. In some examples, once the change to the communication channel 104 is detected, the access control system 108 can modify which nested environment is in communication with or accessible by the client device 106. For example, a switch from the first communication channel 104a to the second communication channel 104b can cause the access control system 108 to revoke access by the client device 106 to the first nested environment 202a. Additionally or alternatively, the access control system 108b can direct traffic or other communications from the client device 106 via the second communication channel 104b to the second nested environment 202b.

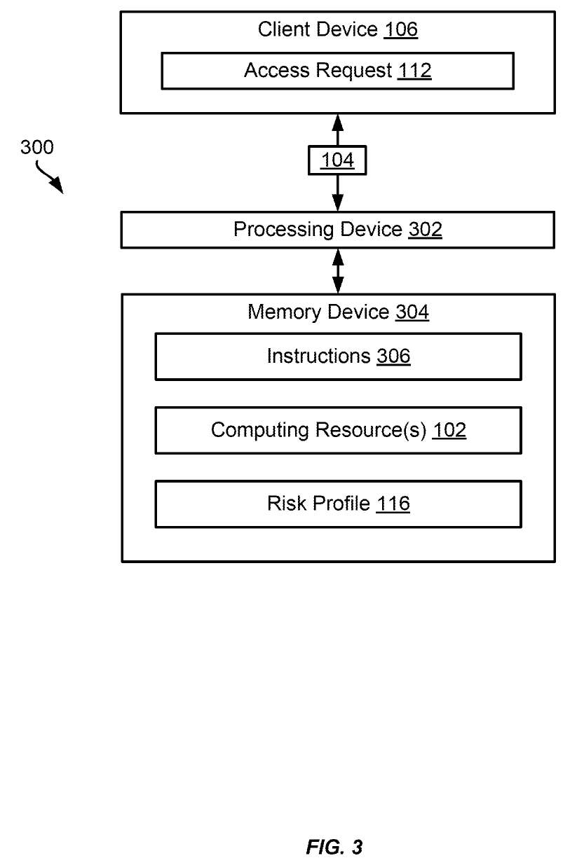

FIG. 3 is a block diagram of another example of a computing environment 300 for using dynamic access control to control access to computing resources 102 based on a communication mechanism according to some examples of the present disclosure. The computing environment 300 can include a processing device 302 communicatively coupled to a memory device 304. Certain aspects of FIG. 3 are described with reference to components described above with respect to FIG. 1.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C#, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can receive an access request 112 from a client device 106, such as transmitted via a communication channel 104 of the client device 106. The access request 112 can indicate a requested computing resource to which the client device 106 is requesting access. For example, the access request 112 can indicate that the client device 106 is requesting access to a specific database, such as to perform a retrieval request. The processing device 302 can determine a risk profile 116 related to the communication channel 104 of the client device 106. The risk profile 116 can quantify a level of trustworthiness or a level of risk associated with the communication channel 104. For example, the processing device 302 can evaluate the communication channel 104 with respect to risk of being compromised by a malicious actor. Security measures, such as encryption or authentication, being implemented for the communication channel 104 can decrease the level of risk associated with the communication channel 104. A lack of the security measures may, in turn, increase the level of risk associated with the communication channel 104. Other parameters (e.g., bandwidth, data loss, connectivity, etc.) associated with the communication channel 104 can be evaluated.

In some examples, the processing device 302 can provide access by the client device 106 to an isolated environment 110 including the requested computing resource. The processing device 302 can configure the isolated environment 110 based on the risk profile 116 of the communication channel 104. For example, the processing device 302 can customize contents of the isolated environment 110 such that the contents accessible by the client device 106 are compatible with the risk profile 116. Accordingly, the processing device 302 can prevent the client device 106 from accessing certain computing resources that the client device 106 is unauthorized to access using the communication channel 104. For example, the communication channel 104 may lack sufficient security to be used to access a file system while having certain permissions, such as write permissions or execute permissions. The processing device 302 may instead customize the isolated environment 110 to enable the client device 106 to access the file system via the communication channel 104 with read permissions only.

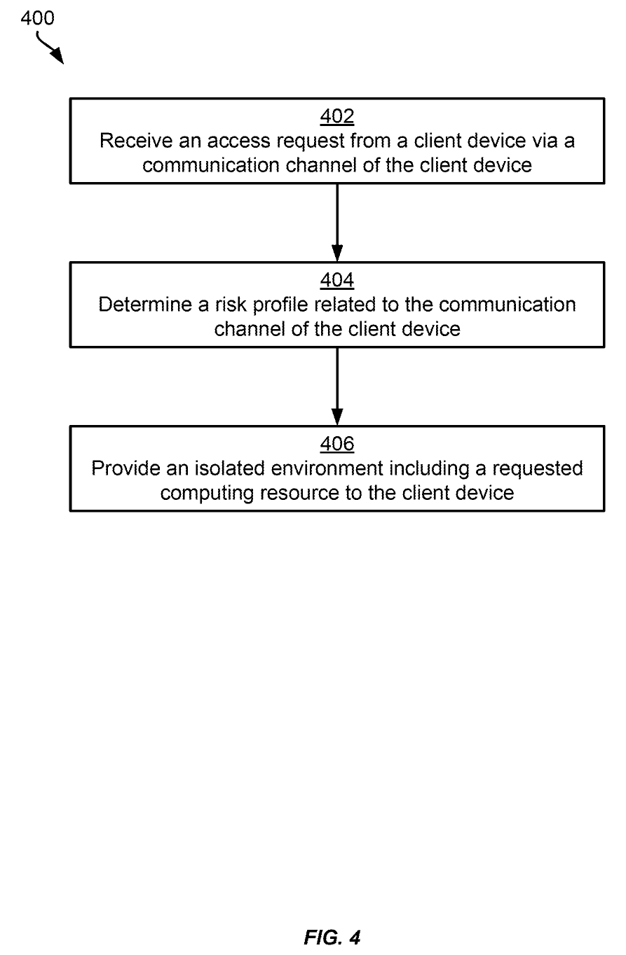

FIG. 4 is a flowchart of a process 400 for using dynamic access control to control access to computing resources 102 based on a communication mechanism according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 receives an access request 112 from a client device 106 via a communication channel 104 of the client device 106. The communication channel 104 can enable wireless communication between the client device 106 and the processing device 302. The access request 112 can indicate a requested computing resource to be accessed by the client device 106. By way of example, the client device 106 can transmit the access request 112 to request access to a database to which access is restricted to prevent unauthorized modifications.

In block 404, the processing device 302 determines a risk profile 116 related to the communication channel 104 of the client device 106. The risk profile 116 can indicate a level of trustworthiness of the communication channel 104. In some examples, the processing device 302 can determine the risk profile 116 based on vulnerabilities associated with the communication channel 104, such as with respect to eavesdropping, interception, or other types of unauthorized access. For example, the processing device 302 can determine whether the communication channel 104 includes protections against unauthorized access, such as an authentication mechanism (e.g., using login credentials, multi-factor authentication, etc.) or encryption.

In block 406, the processing device 302 provides an isolated environment 110 including the requested computing resource to the client device 106. The isolated environment 110 can be generated, selected, or otherwise configured based on the risk profile 116. In some examples, the processing device 302 can manage more than one isolated environment. Each isolated environment can provide a respective set of computing resources 102 that can be suitable to be accessed by certain communication channels having a risk profile above a predefined threshold. The predefined threshold can vary based on the respective set of computing resources 102 deployed or accessible in each isolated environment. In particular, the processing device 302 can determine or set the predefined threshold based on each security requirement of the respective set of computing resources 102. Additionally, or alternatively, the processing device 302 can create one or more nested environments 202 in a particular isolated environment. Each nested environment similarly can include a respective set of computing resources that can be accessible by certain communication channels that have a risk profile above the predefined threshold.

In some examples, the processing device 302 may continually update the isolated environment 110 or the nested environments 202 in response to the communication channel 104 in use by the client device 106. As described herein, the client device 106 can change which communication channel is in use for communication purposes. The processing device 302 can detect a change in the communication channel 104, such as a switch from a current type of communication channel 104 to a different type of communication channel 104. The different type of communication channel 104 can have different characteristics, such as a different communication protocol, compared to the current type of communication channel 104. The change in the communication channel 104 can affect the risk profile 116 used to generate, configure, or select the isolated environment 110. In response to detecting the change in the communication channel 104, the processing device 302 can adjust the isolated environment 110, such as by adding, removing, or otherwise modifying contents of the isolated environment 110. For example, the processing device 302 may replace an existing service deployed in the isolated environment 110 with a different service that has a lower security requirement than the existing service due to the change in the communication channel 104.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving, by an access control system, an access request from a client device via a communication channel of the client device, the access request indicating a requested computing resource to which the client device is requesting access;
determining, by the access control system, a risk profile related to the communication channel of the client device, the risk profile indicating a level of trustworthiness of the communication channel; and
providing, by the access control system, access by the client device to an isolated environment comprising the requested computing resource, the isolated environment configured based on the risk profile.

2. The system of claim 1, wherein the operations further comprise:
detecting a change in the communication channel of the client device, wherein the change in the communication channel affects the risk profile of the communication channel; and
modifying the isolated environment to adjust access by the client device to the requested computing resource.

3. The system of claim 2, wherein the change in the communication channel comprises switching from a first type of communication channel to a second type of communication channel having a different risk profile than the first type of communication channel.

4. The system of claim 1, wherein the isolated environment comprises one or more nested environments that each comprise a respective set of computing resources.

5. The system of claim 4, wherein the operations further comprise:
selecting, by the access control system and based on the risk profile of the communication channel, a particular nested environment of the one or more nested environments comprising the requested computing resource; and
providing, by the access control system and to the client device, access to the particular nested environment.

6. The system of claim 1, wherein the operations further comprise:
determining that the risk profile of the communication channel is compatible with a security requirement associated with the requested computing resource; and
in response to determining that the risk profile of the communication channel is compatible with the security requirement, providing access by the client device to the isolated environment comprising the requested computing resource.

7. The system of claim 1, wherein the access control system is part of a virtual private cloud.

8. A method comprising:
receiving, by an access control system, an access request from a client device via a communication channel of the client device, the access request indicating a requested computing resource to which the client device is requesting access;
determining, by the access control system, a risk profile related to the communication channel of the client device, the risk profile indicating a level of trustworthiness of the communication channel; and
providing, by the access control system, access by the client device to an isolated environment comprising the requested computing resource, the isolated environment configured based on the risk profile.

9. The method of claim 8, further comprising:
detecting a change in the communication channel of the client device, wherein the change in the communication channel affects the risk profile of the communication channel; and
modifying the isolated environment to adjust access by the client device to the requested computing resource.

10. The method of claim 9, wherein the change in the communication channel comprises switching from a first type of communication channel to a second type of communication channel having a different risk profile than the first type of communication channel.

11. The method of claim 8, wherein the isolated environment comprises one or more nested environments that each comprise a respective set of computing resources.

12. The method of claim 11, further comprising:
selecting, by the access control system and based on the risk profile of the communication channel, a particular nested environment of the one or more nested environments comprising the requested computing resource; and
providing, by the access control system and to the client device, access to the particular nested environment.

13. The method of claim 8, further comprising:
determining that the risk profile of the communication channel is compatible with a security requirement associated with the requested computing resource; and
in response to determining that the risk profile of the communication channel is compatible with the security requirement, providing access by the client device to the isolated environment comprising the requested computing resource.

14. The method of claim 8, wherein the access control system is part of a virtual private cloud.

15. A non-transitory computer-readable medium comprising program code executable by a processing device for causing the processing device to perform operations comprising:
receiving, by an access control system, an access request from a client device via a communication channel of the client device, the access request indicating a requested computing resource to which the client device is requesting access;
determining, by the access control system, a risk profile related to the communication channel of the client device, the risk profile indicating a level of trustworthiness of the communication channel; and
providing, by the access control system, access by the client device to an isolated environment comprising the requested computing resource, the isolated environment configured based on the risk profile.

16. The non-transitory computer-readable medium of claim 15, wherein the operations further comprise:
detecting a change in the communication channel of the client device, wherein the change in the communication channel affects the risk profile of the communication channel; and
modifying the isolated environment to adjust access by the client device to the requested computing resource.

17. The non-transitory computer-readable medium of claim 16, wherein the change in the communication channel comprises switching from a first type of communication channel to a second type of communication channel having a different risk profile than the first type of communication channel.

18. The non-transitory computer-readable medium of claim 15, wherein the isolated environment comprises one or more nested environments that each comprise a respective set of computing resources.

19. The non-transitory computer-readable medium of claim 18, wherein the operations further comprise:
selecting, by the access control system and based on the risk profile of the communication channel, a particular nested environment of the one or more nested environments comprising the requested computing resource; and
providing, by the access control system and to the client device, access to the particular nested environment.

20. The non-transitory computer-readable medium of claim 15, wherein the operations further comprise:
determining that the risk profile of the communication channel is compatible with a security requirement associated with the requested computing resource; and
in response to determining that the risk profile of the communication channel is compatible with the security requirement, providing access by the client device to the isolated environment comprising the requested computing resource.
